(19) United States
(12) Patent Application Publication
(10) Pub. No.: US 2007/0159388 A1
(43) Pub. Date: Jul. 12, 2007

(54) COMMUNICATION SYSTEM, A COMMUNICATION TERMINAL AND A METHOD OF DETERMINING A LOCATION ESTIMATE THEREFOR

(75) Inventors: Robert J. Allison, Hampshire (GB); Michael J. Carter, Gloucestershire (GB); Dave Huntingford, Hertfordshire (GB); Raul E. Carpio, Hampshire (GB)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/457,924

(22) Filed: Jul. 17, 2006

(30) Foreign Application Priority Data
Jan. 25, 2005 (US) PCT/US05/02456
Jan. 28, 2004 (GB) 0403118.3

(51) Int. Cl. G01S 5/14

(52) U.S. Cl. 342/357.09; 342/357.1

(57) ABSTRACT

A communication system (100) comprises a plurality of location enabled communication terminals (101, 103). The communication terminals (101, 103) comprise a GPS location processor (111) which generates a location estimate in response to signals received from satellite information data and a plurality of satellites (105). The communication terminals (101, 103) also comprise a transceiver (117, 119, 121) which can form ad-hoc communication links with other communication terminals (101, 103). An ad-hoc controller 123 controls the generation and transmission of a request for satellite information data to another communication terminal (101, 103). The transceiver (117, 119, 121) receives satellite information data from the other communication terminal (101, 103) and the location estimate is determined in response thereto. The ad-hoc controller (123) is furthermore operable to detect a request for satellite information data from another communication terminal (101, 103) and to transmit satellite information data over the ad-hoc communication link in response. Hence, satellite information data may be dynamically and opportunistically shared between communication terminals (101, 103).

### FIELD OF THE INVENTION

The invention relates to a communication system, communication terminal and method of determining a location estimate therefor and in particular to location determination based on signals from a plurality of satellites.

### BACKGROUND OF THE INVENTION

In the last decade, electronic means for determining a location have become increasingly widespread and popular. For example, car or boat navigational systems based on automatic electronic location determination are now prevalent.

The most widely used system for location determination is known as the Global Positioning System (GPS). GPS comprises typically 24 satellites orbiting the earth in low earth orbits. Each of the GPS satellites comprises an accurate time base and transmits radio signals together with timing information indicating the transmission time of the radio signals. A GPS unit may accordingly receive a signal from a GPS satellite and determine the propagation delay as the difference between the transmit time and the time the signal is received. Accordingly, the propagation delay may be used to determine a distance from the satellite to the GPS unit.

When a GPS unit receives signals from three GPS satellites, it can determine the distance between the current location and these three satellites. The GPS satellites furthermore transmit position information indicating the position of the individual GPS satellites (the terms position and location are used interchangeably in this application). As the GPS unit has information related to three fixed points in space and the distance between each of these points and the GPS unit, it may use simple geometric calculations to determine the position of the GPS unit.

The above description assumes that the GPS unit can accurately determine the reception time relative to the transmit time of the GPS satellites. Hence, although the GPS satellites are closely synchronised and have very accurate time bases, this further requires that the GPS unit has a very accurate time base in order to be sufficiently synchronised to the time base of the GPS satellites. An accurate time base is very complex and costly to implement and is unsuitable for e.g. cheap portable units. However, if the GPS unit receives signals from four different satellites, the additional information may be used to determine the unknown time variable thereby allowing an accurate three dimensional position determination without requiring an accurate time base.

The accuracy that can be achieved by a GPS location determination based only on the signals transmitted from the GPS satellites is limited by the accuracy of the satellite position and timing information transmitted. This information is in particular provided by the satellite orbit details (the ephemeris) of the GPS navigation message, which is modulated onto the GPS signals.

One problem associated with GPS units is that the ephemeris data received from the GPS satellites remains valid for only about three or four hours after its transmission. If a GPS receiver is in a low signal strength area (e.g. inside a building), the receiver cannot extract the navigation message (although the position-finding signal itself may still be detectable). In such circumstances, the GPS receiver will not be able to update its ephemeris information from the navigation message, and will therefore eventually lose the ability to determine its position (once its current ephemeris goes out-of-date).

It is known that the accuracy of the location estimates can be enhanced by providing satellite information data to the GPS unit. For example, in assisted GPS, a relatively local GPS correction transmitter may provide additional data that can be used to compensate for inaccuracies in the satellite transmitted ephemeris data. Thus, additional satellite information data such as approximate location, time & date and satellite clock corrections may be transmitted to the GPS unit from a terrestrial source.

In some cases the assistance data may also comprise ephemeris data that can be used by a GPS unit which cannot decode the navigation messages.

Prior art solutions use fixed centralised terrestrial stations to generate and transmit the assistance and ephemeris data. For example, in a radio communication system, a centralised fixed-network based server obtains the relevant data and sends this to the remote devices on the network. Specifically, in a cellular communication system a centralised server located in the fixed network may transmit data to remote units via the base stations of the cellular communication system.

However, a number of disadvantages are associated with such an approach.

Firstly, the solution requires that a complex centralised server is implemented. The management and control functionality associated with a large centralised server operable to interface with a complex communication system is very complex and results in a high cost.

Furthermore, the approach inherently requires that a centralised communication network is present and therefore can only be used in a limited number of applications. Additionally, the approach uses communication resources of the communication system thereby reducing the capacity of the communication system. Also, in a radio communication system, the assistance date can only be received within the coverage area of the radio communication system and may therefore not be ubiquitously available. Therefore location performance (e.g. the location estimate accuracy or a time to first fix) may be degraded in many locations.

Hence, an improved communication system and communication terminals would be advantageous and in particular a communication system and communication terminals providing for improved location estimation accuracy, reduced location estimation time, reduced cost, reduced complexity, increased flexibility, reduced communication resource use and/or reduced reliance on a centralised communication system or network would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a communication system comprising: a first communication terminal comprising: means for determining a location estimate in response to signals received from a plurality of satellites, means for forming an ad-hoc communication link with a second communication terminal, means for transmitting a request for satellite information data to the second communication terminal over the ad-hoc communication link, and means for receiving the satellite information data from the second communication terminal over the ad-hoc communication link; and the second communication terminal comprising: means for generating satellite information data for a satellite location estimation based on the plurality of satellites, means for forming the ad-hoc communication link with the first mobile communication terminal, means for receiving the request for satellite information data from the first communication terminal over the ad-hoc communication link, and means for transmitting the satellite information data to the first communication terminal over the ad-hoc communication link; and wherein the means for determining the location estimate is operable to determine the location estimate in response to the satellite information data.

The inventors have realised that satellite information data may preferably be shared in an ad-hoc environment. Specifically, the inventors have realised that many advantages can be achieved by satellite information data generated in one terminal being communicated to another communication terminal and used for location determination therein.

An ad-hoc communication link may be formed as and when it is possible depending on the current and specific operating conditions e.g. dependent on an availability of communication terminals, radio propagation links etc. Thus, rather than a conventional approach wherein a static, fixed and centralised system is used to transmit satellite information data, ad-hoc communication links are opportunistically formed if possible as and when they are required or desired. Specifically, no static or continuous transmission of satellite information data need to be transmitted but rather ad-hoc communication links may be set up when an opportunity therefor is detected and when satellite information data is required. The ad-hoc communication link may be formed specifically for the purpose of communicating the satellite information data. Hence, the ad-hoc communication is typically temporary and may last only for the duration of the exchange of the satellite information data and any associated data. The ad-hoc communication link requires no centralised control or management as is required in conventional centralised networks. The ad-hoc communication link is thus dynamically set-up and shut down in response to a requirement or desire for satellite information data and the opportunity of receiving this from another terminal.

Rather than relying on a centralised server storing satellite information data and a centralised transmitter transmitting the satellite information data to all communication terminals in the area, satellite information data may in accordance with the current invention e.g. be directly communicated between communication terminals of the communication system as and when this is desirable and possible. Hence, the current invention improves the availability of satellite information data to individual communication terminals. It may thus obviate or reduce the need for a centralised provision of satellite information data although this may exist in addition to the ad-hoc sharing of satellite information data.

The first and/or second communication terminals may e.g. be low complexity location determination units comprising only the communication functionality required for supporting the ad-hoc communication link. The communication system may also be e.g. a complex communication system providing many services and supporting many communication terminals, such as a cellular communication system, or may for example be a simple communication system comprising only the first and second communication terminal.

The invention may provide improved location estimation performance as satellite information data may be available to communication terminals not otherwise having access to this. This may improve location estimation accuracy and/or reduce the estimation delay, such as the time to first fix, and may even enable location determination in locations where it would otherwise not be possible (e.g. in indoor locations where the satellite information cannot be decoded while the position-finding signal itself is still detectable). The requirement for a centralised network, a centralised satellite information data server and/or centralised transmission of satellite information data may be obviated or reduced. Further, no continuous transmission is required and the communication resource use may be reduced thereby increasing the available capacity of the communication system.

The invention may in particular provide a convenient and effective way of extending the area in which satellite navigation may be performed. In particular, the invention may enable indoor location estimation in areas where the necessary data cannot be received directly from the satellites. For example, in an environment comprising a number of indoor devices, those proximal to a window may be able to receive information from the satellites and pass this to other devices which cannot directly receive this information. Hence, the invention may provide the significant advantage of extending the environments in which satellite navigation may be used significantly. This may further provide for a number of enhanced or additional uses of satellite location determination.

The invention may be applied to many different location systems and in particular to Global Navigation Satellite Systems (GNSS) such as the Global Positioning System (GPS) or the upcoming European satellite navigation system known as Galileo.

According to a feature of the invention, the first communication terminal is a mobile terminal. The ad-hoc communication link may specifically be formed in response to the location of the first communication terminal. Hence, as the first communication terminal moves, satellite information data may be obtained in the way most suitable for the current location including from other communication terminals as and when ad-hoc communication links can be established. The invention may provide improved location estimation performance for a mobile communication terminal by dynamically and opportunistically setting up ad-hoc links to other communication terminals as the mobile communication terminal moves in the communication system.

According to a different feature of the invention, the second communication terminal is a mobile terminal.

Preferably, both the first communication terminal and the second communication terminal are mobile terminals. The inventors have realised that as mobile communication terminals move in a communication system, two (or more) location enabled communication terminals may dynamically and typically randomly be in positions wherein the same satellite information data is suitable for both. Accordingly, improved location estimation may be achieved by the communication terminals sharing the satellite information data. Furthermore, the relative positions which are suitable for sharing satellite information data are typically the same positions which are most suitable for forming ad-hoc communication links. Specifically, the first communication terminal and the second communication terminal may form an ad-hoc communication link and communicate satellite information data when they are sufficiently close to each other.

Thus the invention may provide improved location performance by exchanging satellite information data between mobile communication terminals.

According to a different feature of the invention, the ad-hoc communication link is a direct radio connection between the first and second mobile communication terminal. This may facilitate communication through and the setting up of the ad-hoc communication link as well as reduce resource consumption. Specifically, when the distance between communication terminals is low, which is when satellite information data may be particularly suitable for sharing, direct communication links are particularly effective and have low resource usage.

According to a different feature of the invention, the second communication terminal further comprises means for receiving messages from at least one of the plurality of satellites, and the means for generating the satellite information data is operable to generate the satellite information data in response to the messages.

The second communication terminal may preferably generate the satellite information data from e.g. navigation messages from one or more of the satellites. This provides for an efficient and low complexity implementation. For example, if the second communication terminal has direct visibility of the satellites, it may decode the navigation messages and transmit these to a first communication terminal that may not have visibility of the satellites and therefore may not be able to generate the satellite information data. Hence, the invention may increase the locations in which location estimates may be determined without requiring a complex and centralised system.

According to a different feature of the invention, the first communication terminal comprises means for determining a requirement for satellite information data and the means for transmitting the request is operable to transmit the request in response to the requirement.

The requirement may specifically correspond to a necessity for additional satellite information data in order to generate a location estimate. For example, the first communication terminal may only request satellite information data if it determines that it does not currently have valid satellite information data and/or cannot itself retrieve it from the plurality of satellites. This may reduce complexity and facilitate operation as ad-hoc communication links are only set-up and satellite information data only communicated between terminals when desired or required in view of the information already available.

According to a different feature of the invention, the first and second communication terminals are network nodes of a peer-to-peer network.

The first communication terminal and second communication terminal thus provide substantially the same network operation functionality. Specifically, the first communication terminal and second communication terminal may be substantially the same network node type, i.e. they may be considered the same type of terminal by the rest of the network. In some cases the first and second communication terminal may be substantially identical.

According to a different feature of the invention, the first communication terminal comprises means for determining a distance indication between the first and second communication terminal and the means for transmitting the request is operable to transmit the request in response to the distance indication.

Specifically, the request may only be transmitted if the distance indication indicates that the first communication terminal and second communication terminal are sufficiently close. The setting up of the ad-hoc communication link may in some embodiments also be dependent on the distance indication. In some embodiments, the distance indication may be derived implicitly and, for example, the distance indication may simply be determined by whether an ad-hoc communication link can be set up. This is particularly useful for short range ad-hoc communication links where an ad-hoc communication link can only be set up if the communication terminals are relatively close.

The feature may ensure that any satellite information data received originates from a close by communication terminal and is therefore suitable for location estimation.

According to a different feature of the invention the ad-hoc communication link has a range of less than three kilometres, and preferably less than five hundred meters.

This will ensure that only localised assistance is received and/or that the radio resource usage is relatively limited.

Preferably, the ad-hoc communication link is a Bluetooth communication link or an IEEE 802.11 communication link. The ad-hoc communication link may preferably be a wireless local LAN connection. The IEEE 802.11 communication link may for example be an IEEE 802.11a, IEEE 802.11b or IEEE 802.11g communication link.

These communication protocols and standards provide ad-hoc communication performance which is particularly advantageous for the current invention.

According to a different feature of the invention, the satellite information data comprises ephemeris data related to the plurality of satellites. The ephemeris data may specifically relate to the orbit or position of one or more of the plurality of satellites.

According to a different feature of the invention, the satellite information data comprises assistance data operable to improve the location estimate.

The assistance data may specifically be data which is not essential in order to generate a location estimate but which may improve the accuracy and/or reduce the delay of a location estimate. The assistance data may for example be approximate location, time & date and satellite clock corrections.

Preferably, the communication system is an ad-hoc network. For example, the communication system may be an IEEE 802.11a, b or c wireless communication network.

According to a different feature of the invention, the second communication terminal further comprises means for determining a location estimate in response to signals from the plurality of satellites. Specifically, the first communication terminal and second communication terminal may be similar or substantially identical communication terminals.

Preferably the satellites are Global Positioning Satellites. The location determining means preferably uses a GPS location determination algorithm.

According to a second aspect of the invention, there is provided a communication terminal comprising means for determining a location estimate in response to signals received from a plurality of satellites, means for forming an ad-hoc communication link with a second communication terminal, means for transmitting a request for satellite information data to the second communication terminal, and means for receiving the satellite information data from the second communication terminal over the ad-hoc communication link; and wherein the means for determining the location estimate is operable to determine the location estimate in response to the satellite information data.

According to a third aspect of the invention, there is provided a communication terminal comprising: means for determining satellite information data for a satellite location estimation based on a plurality of satellites, means for forming an ad-hoc communication link with a second mobile communication terminal, means for receiving a request for satellite information data from the second communication terminal over the ad-hoc communication link, and means for transmitting the satellite information data to the first communication terminal over the ad-hoc communication link.

According to a fourth aspect of the invention, there is provided a method of location determination comprising in a first communication terminal performing the steps of: determining a location estimate in response to signals received from a plurality of satellites, forming an ad-hoc communication link to a second communication terminal, transmitting a request for satellite information data to the second communication terminal over the ad-hoc communication link, and receiving the satellite information data from the second communication terminal over the ad-hoc communication link; and in the second communication terminal performing the steps of: generating satellite information data for a satellite location estimation based on the plurality of satellites, forming the ad-hoc communication link with the first mobile communication terminal, receiving the request for satellite information data from the first communication terminal over the ad-hoc communication link, and transmitting the satellite information data to the first communication terminal over the ad-hoc communication link; and

wherein the step of determining the location estimate comprises determining the location estimate in response to the satellite information data.

These and other aspects, features and advantages of the invention will be apparent from and elucidated with reference to the embodiment(s) described hereinafter.

Embodiments of the invention will be described, by way of example only, with reference to the accompanying drawings, in which:

### BRIEF DESCRIPTION OF THE DRAWINGS

FIG. 1 illustrates a communication system in accordance with an embodiment of the invention;

FIG. 2 illustrates a method of operation of a communication terminal in accordance with an embodiment of the invention; and

FIG. 3 illustrates a method of operation of a communication terminal in accordance with an embodiment of the invention.

### DETAILED DESCRIPTION OF a PREFERRED EMBODIMENT OF THE INVENTION

The following description concerns an embodiment of the invention applicable to a communication system comprising GPS location enabled terminals and in particular to mobile GPS location terminals comprising short range communication functionality. However, it will be appreciated that the invention is not limited to this application but may be applied to many other systems, applications and terminals including other Global Navigation Satellite Systems such as the Galileo system currently under development.

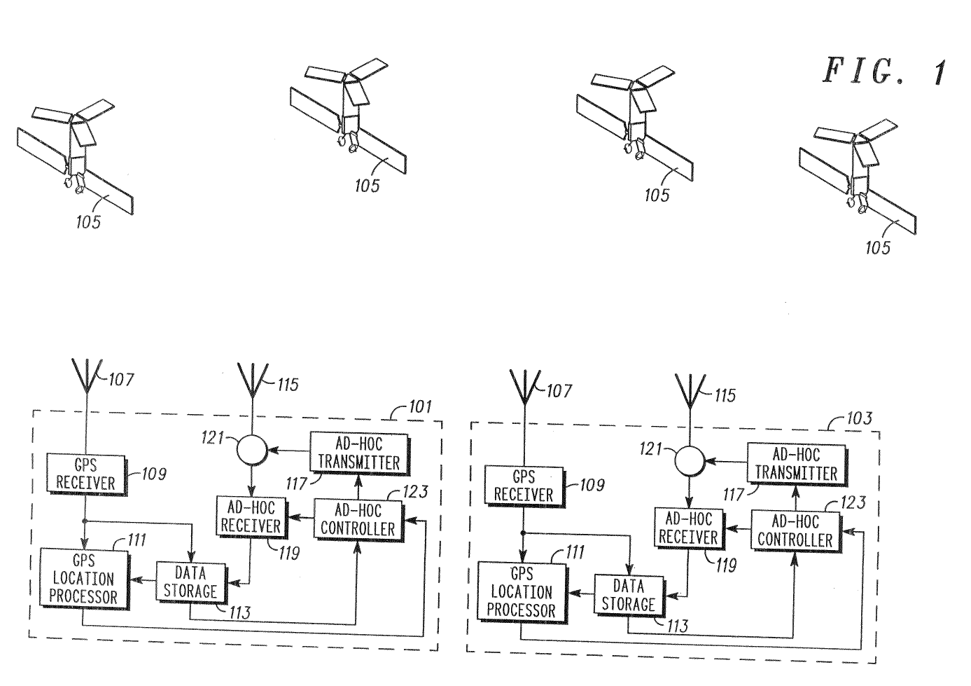

FIG. 1 illustrates a communication system in accordance with an embodiment of the invention. The communication system or communication network comprises a first communication terminal 101 and a second communication terminal.

In the specific embodiment, the first and second communication terminals 101, 103 are substantially identical and are both GPS terminals comprising short range ad-hoc communication functionality such as Bluetooth or IEEE 802.11b functionality. Thus, the first and second GPS terminal 101, 103 are both operable to receive signals from a plurality of GPS satellites 105 and to determine a GPS location estimate based on the received GPS signals.

For brevity and clarity, the description will focus on the components of the first communication terminal 101 and it will be appreciated that the functionality of the second communication terminal 103 is equivalent to that of the first communication terminal 101. In FIG. 1, the same reference numbers are used to refer to identical components of the first and second communication terminal 103.

The first communication terminal 101 comprises a GPS antenna 107 coupled to a GPS receiver 109. The GPS receiver 109 is operable to receive signals from the GPS satellites 105 in order to determine the propagation delays and accordingly the position of the first communication terminal 101. In addition, the GPS receiver 109 comprises functionality for receiving information messages transmitted by the GPS satellites 105 and in particular to demodulate the signals used for location determination in order to derive the information carried thereon. Thus, the GPS receiver 109 may specifically receive the navigation messages transmitted by the GPS satellites 105. The navigation messages comprise satellite information data such as ephemeris data for the GPS satellites 105.

The GPS receiver 115 is coupled to a GPS location processor 111 which is operable to determine a GPS location estimate based on the signals transmitted from the GPS satellites 105.

The GPS location processor 111 is furthermore coupled to a data store 113 from where it may retrieve previously stored satellite information data that may be used in the determination of the GPS location estimate. It will be appreciated that any suitable method or algorithm for determining a GPS location estimate may be used without detracting from the invention. Specifically, the GPS location processor 111 may determine the GPS location estimate in accordance with a conventional GPS location estimation algorithm as will be known to the person skilled in the art.

The GPS receiver 107 is also coupled to the data store 113 and is operable to store satellite information data received from the GPS satellites 105 in the data store 113. Thus, when navigation messages are received by the GPS receiver 107 the extracted satellite information data is stored in the data store 113 for use in location determination by the GPS location processor 111. Accordingly, when the GPS location processor 111 is requested to generate a location estimate it may do so immediately without having to wait for the required information to be received in navigation messages.

The satellite information data may not only be received from the GPS satellites 105 but alternatively or additionally may also be received from ab ad-hoc communication link formed with another communication terminal.

The satellite information data may be any suitable information that assists, facilitates, improves, enables or speeds up the determination of a location estimate based on the signals from the GPS satellites 105. Specifically, the satellite information data may comprise ephemeris data related to the physical position or orbit of the satellites. In some embodiments, the satellite information may comprise satellite information data including correction terms or compensation parameters that may be included in the location determination. It may be particularly advantageous for the satellite information to comprise information that enables or assists the subscriber unit in determining which satellites out of the total satellite constellation are currently visible to the subscriber unit. The satellite information preferably also comprises specific parameters which are required or desired in order to detect and lock on to the signals from these satellites. For example, the satellite information may comprise the transmit frequency and/or transmit code and/or identity of the individual satellites. In the described embodiment, the satellite information comprises the information transmitted by the GPS satellites 105 in the GPS navigation messages including the ephemeris data.

The satellite information data stored in the data store 113 may comprise data received directly from the GPS satellites 105, data received over the ad-hoc communication link and may specifically be a combination of these. For example, the stored satellite information data may comprise assistance data which is not essential for a location determination and which is not transmitted by the satellites 105. This assistance data may be received over the ad-hoc communication link and may comprise information that improves the accuracy of the location estimate. However, in the described embodiment, all of the stored satellite information data may potentially be received through the ad-hoc communication link.

In order to communicate over the ad-hoc communication link, the first communication terminal 101 comprises an ad-hoc antenna 115 which is coupled to an ad-hoc transmitter 117 and an ad-hoc receiver 119 through a duplexer 121. The duplexer isolates the ad-hoc transmitter 117 and the ad-hoc receiver 119 thereby allowing them to use the same antenna 115. In some embodiments, the duplexer 121 may be replaced by a switch.

The ad-hoc receiver 119 is in the described embodiment an IEEE 802.11b receiver and the ad-hoc transmitter 117 is an IEEE 802.11b transmitter. Thus, the first communication terminal is capable of setting up IEEE 802.11b ad-hoc communication links to other communication terminals and to communicate with these in accordance with the IEEE 802.11b standard.

In the specific embodiment, the communication system is a complete ad-hoc IEEE 802.11b network. In the network, each IEEE 802.11b terminal continuously scans for other IEEE 802.11b terminals and if another IEEE 802.11b terminal is detected, an ad-hoc communication link is set up. Thus, rather than having a centralised network which is responsible for the network operation and through which is communicated, the ad-hoc network is a distributed network wherein temporary connections are typically formed in an opportunistic way and generally for a specific purpose. Thus, the configuration of the ad-hoc network changes dynamically as communication terminals move and as communication terminals enter and leave the communication system in a known manner.

The ad-hoc receiver 119 and the ad-hoc transmitter 117 are furthermore coupled to an ad-hoc controller 123. The ad-hoc controller 123 is operable to control the operation of the ad-hoc communication functionality and is specifically operable to control the ad-hoc receiver 119 and the ad-hoc transmitter 117 to setup an ad-hoc communication link and to transmit and receive satellite information data through the ad-hoc communication link.

The ad-hoc controller 123 is furthermore coupled to the data store 113 and to the GPS location processor 111. The ad-hoc controller 123 may receive location estimates from the GPS location processor 111 and may base the ad-hoc operation on these location estimates. The ad-hoc controller 123 may also retrieve satellite information data from the data store 113 in order to transmit this through the ad-hoc communication link. Furthermore, the ad-hoc receiver 119 is coupled to the data store 113 and may under the control of the ad-hoc controller 123 store received satellite information data in the data store 113.

As the first communication terminal moves in the communication system, the ad-hoc controller 123 controls the ad-hoc transmitter 117 to transmit beacon signals that may be detected by other ad-hoc communication terminals. In addition, the ad-hoc controller 123 controls the ad-hoc receiver 119 to scan for beacon signals from other ad-hoc terminals. If a beacon signal is detected the ad-hoc controller 123 controls the ad-hoc transmitter 117 to transmit a communication request to the other communication terminal. An ad-hoc communication link may then be set up in accordance with the IEEE 802.11b standard as is known to the skilled person. Likewise, if a communication request is received from another communication terminal, which has detected the first communication terminal's 101 beacon message, an ad-hoc communication link may also be set up in accordance with the IEEE 802.11b standard.

In the described embodiment, the first communication terminal 101 may operate either as a recipient of satellite information data or as a source of satellite information data. The ad-hoc controller 123 may specifically determine if the data store 113 comprises valid satellite information data. If so, the first communication terminal 101 may act as a source of satellite information data and otherwise it may seek to receive satellite information data. It will be appreciated that any suitable algorithm or criterion for determining if the first communication terminal 101 will attempt to receive or transmit satellite information data may be used and that indeed the first communication terminal 101 may for a given ad-hoc communication link function as both a transmitter and receiver of satellite information data.

If the data store 113 in the described embodiment does not comprise valid or accurate satellite information data, the ad-hoc controller 123 controls the ad-hoc transmitter 117 to transmit a satellite information data request message to the second communication terminal 103. If the second communication terminal 103 comprises valid satellite information data, this will be transmitted to the first communication terminal 101. The ad-hoc receiver 119 will store the satellite information data in the data store 113. It may then proceed to terminate the ad-hoc communication link in order to reduce power consumption. Thereby the first communication terminal 101 will have received satellite information data that will allow it to perform location estimates which otherwise would not be possible. For example, if the first communication terminal 101 is in a low signal strength area (e.g. inside a building), the GPS receiver 109 may not be able to extract the navigation message although the signal strength is sufficient to estimate propagation delays. Generally this would prevent location estimation but in accordance with the described embodiment the satellite information data may be received from another communication terminal thereby enabling location estimates to be derived. The second communication terminal 103 may for example be located outside the building.

The improved location performance is achieved without any need or reliance on a centralised server, database or transmission of satellite information data. Hence, improved location performance may be achieved in low cost and low complexity communication systems. The described principles are thus particularly suitable for peer to peer ad-hoc networks such as Bluetooth or IEEE 802.11.

If the data store 113 in the described embodiment does comprise valid or accurate satellite information data, the ad-hoc controller 123 controls the ad-hoc transmitter 117 not to transmit a satellite information data request message to the second communication terminal 103. However, if it receives a satellite information data request message from the second communication terminal 105, the ad-hoc controller 123 retrieves the satellite information data from the data store 113 and transmits it to the second communication terminal 103 over the ad-hoc communication link.

It will be appreciated that the communicated satellite information does not necessarily comprise only essential data. Rather, it may additionally or alternatively comprise satellite information data which is not essential but which may improve the performance. For example, the communicated satellite information data may comprise assistance data which can improve the reliability or accuracy of the location estimate and/or the location estimation time.

It will also be appreciated that the satellite information data which is communicated to or from the second communication terminal 103 is not necessarily the entire satellite information data stored in the data store 113 but may be a subset of this data. For example, the first communication terminal 101 may transmit or receive only the satellite information data which has been received from the GPS satellites 105, only the assistance data which is not essential to location estimation or any other suitable subset. Furthermore, the satellite information data request message may in some embodiments identify specific satellite information data which is desired and the second communication terminal 103 may communicate only this information.

It will also be appreciated that the satellite information data exchange is not necessarily in one direction for a given ad-hoc communication link. Rather, in some embodiments, communication terminals may continuously monitor for other communication terminals and whenever one is encountered, the two communication terminals may exchange all the satellite information data they have. Each of the communication terminals subsequently processes the received satellite information data and stores or updates only that which according to a given criterion is the more suitable than what is already stored. Specifically, the data elements of the satellite information data may comprise a time stamp and the terminals may simply store the most recent data element out of the two. As another example, the data elements of the satellite information data may comprise a location indication and the terminals may simply store the data element having a location closest to the current location. The location and time approach is preferably combined and different criterions may be used for each data element type to reflect the sensitivity of the specific data element type to various parameters. In such embodiments, as ad-hoc terminals move around in the communication system, satellite information data will be exchanged by terminals coming into contact with each other and satellite information is thus automatically distributed in the system.

It will be appreciated that different criteria for setting up the ad-hoc communication link may be used. For example, the ad-hoc controller 123 may only set-up the communication link if it requires satellite information data in order to perform a location estimate. Likewise the ad-hoc communication link may only be set up if the ad-hoc controller 123 determines that the data store 113 comprises satellite information data that may be of assistance to other communication terminals. As an example, the ad-hoc controller 123 may control the ad-hoc receiver 119 to only scan for other communication terminals if satellite information data is required and to only transmit a beacon signal if the data store 113 comprises valid satellite information data that may be transmitted to other communication terminals.

In some embodiments, the first communication terminal 101 and the second communication terminal 103 may be subscriber units of a cellular communication system which comprises means for setting up ad-hoc communication links with other subscriber units. For example, the first and second communication terminal may be standard cellular subscriber units which furthermore comprise IEEE 802.11 or Bluetooth communication functionality for communicating with other communication terminals.

However, the ad-hoc communication link may also be formed by a direct communication link within the specifications of the cellular communication system. For example, the first and second communication terminals 101, 103 may be TETRA subscriber units capable of setting up Direct Mode Operation (DMO) communication links with each other.

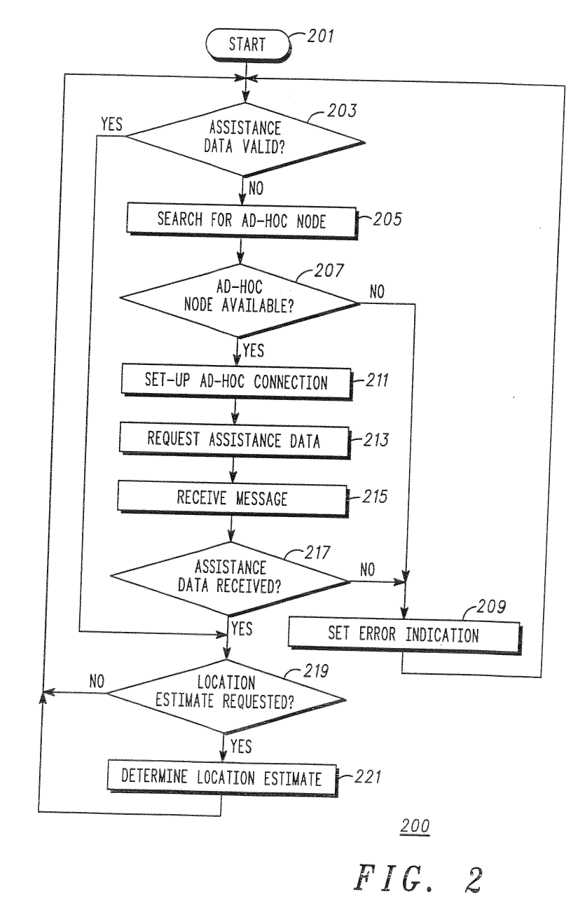

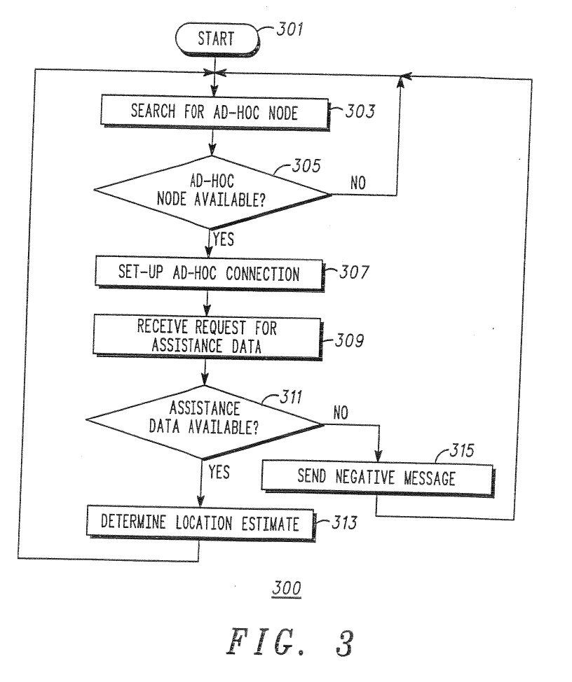

FIGS. 2 and 3 illustrate a method of operation of two communication terminals in accordance with an embodiment of the invention. A specific example of a method of location determination will be described in the following based on FIGS. 2 and 3. The method is applicable to the communication system of FIG. 1 and will be described with reference to this. In the specific example, the first communication terminal 101 is located within a building where the signal strength from the satellites is sufficient for determining a timing of the signals (and thus a propagation delay) but insufficient for reception of the navigation messages. The second communication terminal 103 is located outside the building and receives a strong satellite signal. In the example, the first communication terminal 101 may for example correspond to a portable GPS unit being carried inside a building by a policeman, and the second communication terminal 105 may be a vehicle based GPS unit in the patrol car. The figures in particular show the operation which is controlled by the ad-hoc controllers 123 of the first communication terminal 101 and the second communication terminal 103.

FIG. 2 illustrates the method steps being performed in the first communication terminal 101 and FIG. 3 illustrates the method steps being performed in the second communication terminal 103.

The method 200 initiates in step 201 which is followed by step 203. In step 203, the first communication terminal 101 determines if the satellite information data stored in the data store 113 is valid and sufficient to produce a GPS location estimate. In the described embodiment, the first communication terminal 101 only proceeds to set up ad-hoc communication links and to request satellite information data if the stored satellite information data is insufficient to make a location estimate. Thus, if the stored satellite information data is valid and sufficient, the method skips the communication steps and proceeds to step 219. This provides for the communication means only being powered on when necessary thereby reducing power consumption.

If the stored satellite information data is not valid or not sufficient to provide the basis of a location estimate, the first communication terminal 101 assumes that this is because it has not been able to receive navigation messages from the GPS satellites 105 for some time. This may happen for example if the policeman has been in the building for three to four hours. The first communication terminal 101 therefore seeks to receive the satellite information data from another communication terminal and in particular will attempt to retrieve it from the second communication terminal 103 which in the example is the GPS unit located in the patrol car.

Step 203 is accordingly followed by step 205 where the first communication terminal 101 searches for a second ad-hoc node and particularly searches for the second communication terminal 103 located in the patrol car.

Step 205 is followed by step 207 wherein it is determined if another ad-hoc communication terminal has been found. In the specific example, the first communication terminal 101 specifically searches for the second communication terminal 103 in the patrol car. Therefore the method in step 207 determines if an ad-hoc terminal having the identity of the second communication terminal 103 has been detected. If not, satellite information data cannot be retrieved through the ad-hoc communication link and therefore no location estimate can be generated. The method continues in step 209 wherein an error indication is set indicating the failure to generate a location estimate.

It will be appreciated that in other embodiments, the first communication terminal 101 is not limited to searching for a specific communication terminal for exchange of satellite information data but may search for a group of terminals or for any possible terminal.

If the second communication terminal 103 is identified, step 207 is followed by step 211 wherein the ad-hoc communication link is set up using any suitable algorithm. Specifically, the ad-hoc communication link connection may be an IEEE 802.11b or Bluetooth connection set up in accordance with the IEEE 802.11b or Bluetooth standard. However, for the specific application, the ad-hoc communication link is preferably set up as a direct mode communication link within a private mobile radio system in order to provide the desired security and privacy.

When the ad-hoc communication link has been set-up, step 211 is followed by step 213, wherein the first communication terminal requests satellite information data from the second communication terminal 103.

Step 213 is followed by step 215 wherein a message is received from the second communication terminal 103. The message may comprise the satellite information data or may comprise an indication that no suitable satellite information data was available.

Step 215 is followed by step 217 wherein it is determined if the message comprised the satellite information data. If not, no location estimate can be generated and the method continues in step 209 wherein an error indication is set to indicate this.

If satellite information data has been received, step 217 is followed by step 219 wherein it is determined if a location estimate is currently required. If not, the method returns to step 203. However, if a location estimate is required, the method continues in step 221 by generating the location estimate using the satellite information data. Following step 221, the method returns to step 203.

Thus, the method implements a polling loop which continuously checks if the satellite information data is valid and if a location estimate is required. If the satellite information data is not valid, it attempts to retrieve satellite information data from the second communication terminal. Hence, as long as satellite information data is received by the GPS receiver 113 (i.e. in parallel to the method of FIG. 2) the satellite information data will be valid and no action is taken by the ad-hoc controller 123. However, if the satellite information data cannot be received, the ad-hoc controller 123 will automatically try to retrieve it from the second communication terminal 103.

FIG. 3 shows the operation of the second communication terminal 103 in the specific example. The method starts in step 301.

Step 301 is followed by step 303 wherein the second communication terminal 103 searches for a other ad-hoc nodes and particularly searches for the first communication terminal 101.

Step 303 is followed by step 305 wherein it is determined if another ad-hoc communication terminal has been found. In the specific example, the second communication terminal 103 specifically searches for the first communication terminal 101. Therefore, the method in step 305 determines if an ad-hoc terminal having the identity of the first communication terminal 101 has been detected. If not, the method returns to step 203 and the second communication terminal 103 continues to scan for the first communication terminal 101.

If the first communication terminal 101 is detected, the method continues in step 307 wherein the ad-hoc communication link is formed to the first communication terminal 101.

Step 307 is followed by step 309 wherein the second communication terminal 103 receives the request for satellite information data which was transmitted by the first communication terminal 101 in step 213.

Step 309 is followed by step 311, wherein the ad-hoc controller 123 of the second communication terminal 103 determines if it has stored satellite information data that may be suitable for the first communication terminal 101. Specifically, if the second communication terminal 103 finds that it has currently valid satellite information data stored, the method continues in step 213 by the second communication terminal transmitting the satellite information data. The method then returns to step 203. If the second communication terminal 103 finds that it does not have valid satellite information data, the method continues in step 315 where a message is transmitted that comprises an indication that no satellite information data is available. The method then returns to step 203.

Hence, the ad-hoc controller 123 of the second communication terminal 103 may continuously monitor for the first communication terminal 101 and if detected and a request for satellite information data is received, the second communication terminal 103 transmits any available satellite information data.

The ad-hoc communication link is preferably a short range communication link such as that of an IEEE 802.11b or Bluetooth system. Preferably, the range is less than 3 kilometres. This will ensure that ad-hoc communication links are only setup if the communication terminals are relatively close, thereby limiting the number of communication links in the system. Furthermore, this will ensure that communication terminals exchanging satellite information data are sufficiently close for the satellite information data to be appropriate for the receiving communication unit. In some embodiments, an improved reliability and/or accuracy is required and the range of the ad-hoc communication link is preferably less than 500 meters. In some embodiments, the communication terminals may explicitly determine a distance between the communication terminals and only request satellite information data if the distance is sufficiently low.

The invention can be implemented in any suitable form including hardware, software, firmware or any combination of these. However, preferably, the invention is implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. In addition, singular references do not exclude a plurality. Thus references to “a”, “an”, “first”, “second” etc do not preclude a plurality.

1. A communication system comprising:
a first communication terminal comprising
means for determining a location estimate in response to signals received from a plurality of satellites,
means for forming an ad-hoc communication link to a second communication terminal,
means for transmitting a request for satellite information data to the second communication terminal over the ad-hoc communication link, and
means for receiving the satellite information data from the second communication terminal over the ad-hoc communication link; and
the second communication terminal comprising:
means for generating satellite information data for a satellite location estimation based on the plurality of satellites,
means for forming the ad-hoc communication link with the first mobile communication terminal,
means for receiving the request for satellite information data from the first communication terminal over the ad-hoc communication link, and
means for transmitting the satellite information data to the first communication terminal over the ad-hoc communication link; and
wherein the means for determining the location estimate is operable to determine the location estimate in response to the satellite information data.

2. A communication system as claimed in claim 1 wherein the first communication terminal is a mobile terminal.

3. A communication system as claimed in claim 2 wherein the second communication terminal is a mobile terminal.

4. A communication system as claimed in claim 3 wherein the ad-hoc communication link is a direct radio connection between the first and second mobile communication terminals.

5. A communication system as claimed in claim 4 wherein the second communication terminal further comprises means for receiving messages from at least one of the plurality of satellites, and wherein the means for generating the satellite information data is operable to generate the satellite information data in response to the messages.

6. A communication system as claimed in claim 5 wherein the first communication terminal comprises means for determining a requirement for satellite information data and the means for transmitting the request is operable to transmit the request in response to the requirement.

7. A communication system as claimed in claim 6 wherein the first and second communication terminals are network nodes of a peer-to-peer network.

8. A communication system as claimed in claim 7 wherein the first communication terminal comprises means for determining a distance indication between the first and second communication terminal and the means for transmitting the request is operable to transmit the request in response to the distance indication.

9. A communication system as claimed in claim 8 wherein the ad-hoc communication link has a range of less than three kilometres.

10. A communication system as claimed in claim 9 wherein the ad-hoc communication link has a range of less than five hundred meters.
